(19) United States
(12) Patent Application Publication
(10) Pub. No.: US 2026/0127184 A1
(43) Pub. Date: May 7, 2026

(54) AUTOMATED LINKAGE OF ANCHOR PAGES

(71) Applicant: Walmart Apollo, LLC, Bentonville, AR (US)

(72) Inventors: Xia Zhao, Santa Clara, CA (US); Silu Wang, Santa Clara, CA (US); Bingjie Huang, Sunnyvale, CA (US); Wei Shen, Pleasanton, CA (US)

(21) Appl. No.: 18/940,316

(22) Filed: Nov. 7, 2024

(51) Int. Cl. G06F 16/2457; G06F 16/953

(52) U.S. Cl. CPC G06F 16/24578; G06F 16/953

(57) ABSTRACT

Example implementations relate to automated modification of interface pages to include relevant link information. In an example, an anchor page and a plurality of candidate pages are obtained and an embedding is generated for each page by applying a page embedding model to a representative keyword construction extracted from each of the at least one anchor page or a candidate page of the plurality of candidate pages. A set of similar candidate pages is selected using a comparison of the embeddings and a relevance score is determined for each candidate page. The relevance score represents a relevance of a candidate page to the anchor page. A diversification score is generated for each candidate page and a linked set of candidate pages is selected based on the relevance scores and diversification scores. The anchor page is modified to include a link to each page in the linked set.

### TECHNICAL FIELD

This application relates generally to network linkage, and more particularly, to linking network pages to improve interface navigability.

### BACKGROUND

Automated indexing and search functions, such as search engines, rely on multiple factors to identify relevant interface pages in response to user queries, such as content relevancy, sitemaps, content quality evaluations, internal interlinking, and user experience feedback. Although these systems utilize multiple factors, one or more factors, such as internal interlinking, are more significant weighting factors for determining search results. An interface page, such as a webpage, that scores low on a significant factor, such as internal interlinking, may not be returned in search results despite being highly relevant, high quality, and of interest to a user.

When adding new interface pages to existing interface sets (e.g., websites), the added interface pages may have limited, if any, links to other pages within the existing interface set. Some current systems utilize manual processes to update some existing interface pages that have content related to the added pages, such as topic pages, summary pages, etc., but these manual processes are cumbersome and cannot be applied to systems having a large volume of interface pages. Similarly, if a system relies on rotating pages, such as seasonal pages, the newly generated seasonal pages are manually generated to include linkages to all relevant pages, presenting similar issues to manual updates of existing pages but additionally adding a time constraint.

### BRIEF DESCRIPTION OF THE DRAWINGS

Various examples will be described below with reference to the following figures.

FIG. 1 depicts an example system for automatically generating network linkages for an interface page, in accordance with some embodiments.

FIG. 2 depicts an example system for generating linked evergreen anchor pages and linked seasonal anchor pages, in accordance with some embodiments.

FIG. 3 depicts an example system for selecting a set of candidate anchor pages for link generation, in accordance with some embodiments.

FIG. 4 depicts an example system for page embedding generation, in accordance with some embodiments.

FIG. 5 depicts an example system for page diversification, in accordance with some embodiments.

FIG. 6 is a flowchart depicting an example method for automatically generating linked anchor pages, in accordance with some embodiments.

FIG. 7 depicts an example system with a machine-readable medium that includes instructions for automatically generating linked anchor pages, in accordance with some embodiments.

FIG. 8 depicts an example computer system that implements one or more of the disclosed processes, in accordance with some embodiments.

### DETAILED DESCRIPTION

The disclosed systems and methods for generating network linkages provide an automated process that allows for automatic generation of interface linkages for inclusion in an interface page to enhance the corresponding interface page interlinking in a network environment without manual interaction. In some embodiments, the identification of a set of candidate pages for linking within a corresponding anchor page based on generated embeddings, a relevance score, and/or a corresponding diversification score allows for automatic identification of relevant pages that enhance interlinking tasks, such as mapping for automated traversal of network structures by search engines or other indexing processes. In some embodiments, the identification of seasonal pages and corresponding linkage based on one or more seasonal features provides for enhancement of short-term or rotated interface pages within usable timeframes to enhance the automated traversal of network structures by search engines or other indexing processes corresponding to seasonal updates or refreshes.

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless) to one another, either directly or indirectly, through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In various embodiments, a system for generating linkages between network pages is disclosed. The system includes a processor and a non-transitory memory storing instructions. The instructions, when executed, cause the processor to obtain at least one anchor page candidate and a plurality of eligible page candidates from a database and generate an embedding for the at least one anchor page candidate and each of the plurality of eligible page candidates. The embedding is generated by an embedding module that applies a page embedding model to representative keyword constructions extracted from the at least one anchor page candidate or an eligible page candidate of the plurality of eligible page candidates. A set of similar attributes is determined for the at least one anchor page candidate and each eligible page candidate. The set of similar attributes is determined by a retrieval module. A relevance score is determined for each eligible page candidate representative of a relevance of the eligible page candidate to the at least one anchor page candidate and each eligible page candidate is ranked based on a relevance score and one or more page parameters. A diversification score is generated for each eligible page candidate, a linked set of eligible page candidates is selected based on the rank and diversification score for each eligible page candidate, and the at least one anchor page is modified to include a link to each page in the linked set of eligible page candidates.

In various embodiments, a computer-implemented method is disclosed. The computer-implemented method includes steps of obtaining at least one anchor page candidate and a plurality of eligible page candidates from a database and generating an embedding for the at least one anchor page candidate and each of the plurality of eligible page candidates. The embedding is generated by an embedding module that applies a page embedding model to representative keyword constructions extracted from the at least one anchor page candidate or an eligible page candidate of the plurality of eligible page candidates. The computer-implemented method includes a step of determining a set of similar attributes for the at least one anchor page candidate and each eligible page candidate. The set of similar attributes is determined by a retrieval module. The computer-implemented method includes steps of determining a relevance score for each eligible page candidate representative of a relevance of the eligible page candidate to the at least one anchor page candidate, ranking each eligible page candidate based on a relevance score and one or more page parameters, generating a diversification score for each eligible page candidate, selecting a linked set of eligible page candidates based on the rank and diversification score for each eligible page candidate, and modifying the at least one anchor page to include a link to each page in the linked set of eligible page candidates.

In various embodiments, a non-transitory computer-readable medium having instructions stored thereon is disclosed. The instructions, when executed by at least one processor, cause at least one device to perform operations including obtaining at least one anchor page candidate and a plurality of eligible page candidates from a database and generating an embedding for the at least one anchor page candidate and each of the plurality of eligible page candidates. The embedding is generated by an embedding module that applies a page embedding model to representative keyword constructions extracted from the at least one anchor page candidate or an eligible page candidate of the plurality of eligible page candidates. The instructions further cause the at least one device to perform an operation of determining a set of similar attributes for the at least one anchor page candidate and each eligible page candidate. The set of similar attributes is determined by a retrieval module. The instructions further cause the at least one device to perform operations including determining a relevance score for each eligible page candidate representative of a relevance of the eligible page candidate to the at least one anchor page candidate, ranking each eligible page candidate based on a relevance score and one or more page parameters, generating a diversification score for each eligible page candidate, selecting a linked set of eligible page candidates based on the rank and diversification score for each eligible page candidate, and modifying the at least one anchor page to include a link to each page in the linked set of eligible page candidates.

Furthermore, in the following, various embodiments are described with respect to methods and systems for generating network linkages between interface pages (e.g. website pages, intranet pages) to improve automated searching and indexing of the interface pages and to provide an improved user interface for user navigation. In various embodiments, anchor pages having very few or no existing linkages to other interface pages are processed to programmatically add linkages to relevant pages within the interface. The programmatic processing identifies eligible page candidates among available network pages for one or more anchor pages. The page candidates are processed to determine a most relevant and diverse set of interface pages to be linked to the relevant anchor page. After identifying a set of relevant page candidates, the system automatically updates the relevant anchor page to include links to each of the relevant page candidates, allowing for linkage searches and user navigation to utilize the linkages to identify relevant content and/or navigate the interface.

In some embodiments, methods and systems for generating network linkages may update a linkage module provided within an interface page. Linkage models may include, but are not limited to, hidden portions of an interface page that contain lists or sets of links to other relevant interface pages in order to provide adequate guidance and mapping for automated traversal of network structures by search engines or other indexing processes. The linkage module may be a non-rendered portion of the interface page that is accessible via the interface code and/or through one or more programmatic interfaces, such as an application programming interface (API).

In some embodiments, systems and methods for generating network linkages include one or more trained models, such as one or more trained embedding models, one or more nearest-neighbor search models, etc. As discussed in greater detail below, each of the disclosed models is trained or fine-tuned to operate on corresponding data elements provided by the system.

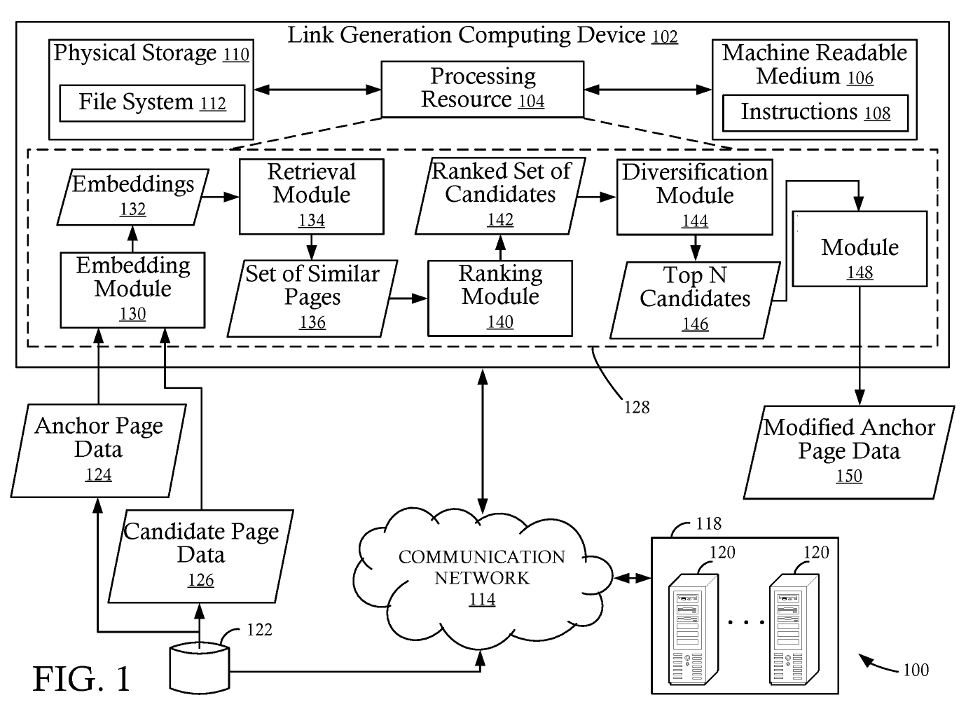

FIG. 1 depicts an example system 100 for automatically generating network linkages for an interface page, in accordance with some embodiments. The system 100 includes a link generation computing device 102 that provides a link generation process 128. As discussed in greater detail below, the link generation process 128 receives an anchor page candidate and populates or modifies a linkage module of the anchor page candidate to include links to relevant additional interface pages. The link generation computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The link generation computing device 102 includes a non-transitory machine-readable medium 106 that may include one or more of a random-access memory (RAM), read-only memory (ROM), electrically erasable programmable read-only memory (EEPROM), flash memory, hard disk, and/or any other suitable memory resource.

The processing resource 104 may execute instructions 108 (e.g., programming or software code) stored on machine-readable medium 106 to perform functions of the link generation computing device 102, such as implementation of the link generation process 128, generation of link information, and updating of linkage modules for received anchor pages. The instructions 108 may include instructions for implementing one or more models. In some embodiments, and as will be described further herein below, the link generation computing device 102 may execute one or more models, processes, or algorithms, such as a machine-learning model, deep-learning model, or statistical model (e.g., as implemented as machine-readable instructions), to identify relevant candidate pages within a network interface, select a set of relevant and diverse candidate pages for linkage within a selected anchor page, and update a linkage module of the anchor page to include links to the selected set of candidate pages.

The link generation computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (e.g., installed) in the link generation computing device 102. In some implementations, physical storage 110 may be accessed as a block storage device.

In some cases, the link generation computing device 102 may also include a local file system 112 that may be implemented as a layer on top of the physical storage 110. For example, an operating system may be executing on the link generation computing device 102 (by virtue of the processing resource 104 executing certain instructions 108 related to the operating system) and the operating system may provide a file system 112 to store data on the physical storage 110.

The network 114 may enable a plurality of devices or systems to communicate with the link generation computing device 102 over one or more network channels, illustrated as a network cloud. For example, in various embodiments, the link generation computing device 102 may be in communication with one or more a cloud-based engines or servers 118, such as one or more processing devices 120 that may be provisioned for use (e.g., a web server, a processing server), a database 122, a workstation, and/or any other suitable system or device.

The link generation computing device 102, for example, through the processing resource 104, implements a machine learning-based link generation process 128. An embedding module 130 of the link generation process 128 receives anchor page data 124 and candidate page data 126 from one or more data stores, such as a network interface page database 122. The anchor page data 124 includes one or more anchor pages to be modified to include links to one or more relevant pages in the candidate page data 126. The anchor page data 124, the candidate page data 126, or both may be representative of interface pages within a network environment, such as a webpage, intranet, etc.

In some embodiments, the anchor page data 124 includes a curated set of anchor pages, such as a set of seasonal anchor pages identified by one or more selection processes. Similarly, the candidate page data 126 may include a subset of pages in a network interface environment. The set of seasonal anchor pages and/or a subset of the pages in the network interface may be selected based on one or more selection criteria, such as, for example, filtering for seasonally associated pages or interface elements.

In response to receiving the anchor page data 124 and the candidate page data 126, the embedding module 130 generates an embedding 132 for each page represented in the anchor page data 124 and the candidate page data 126. The embedding module 130 may implement one or more embedding models to generate relevant embeddings 132. For example, the embedding module 130 may implement a page embedding model that receives a relevant page (e.g., an anchor page or candidate page) and generates one or more embeddings 132 for each page that is a representation (e.g., numerical or vector representation) of keyword constructions extracted from the corresponding page. Implemented embedding models may include, but are not limited to, Bidirectional Encoder Representations from Transformers (BERT) models. The generated embeddings 132 may be representative of a page name, a page path, one or more frequently appearing product types, and/or any other elements of an interface page.

A retrieval module 134 determines (e.g., identifies) pages in the candidate page data 126 that are similar to an anchor page in the anchor page data 124 and outputs the similar pages as a set of similar pages 136. In some embodiments, the retrieval module 134 utilizes a nearest neighbor search (such as an Approximate Nearest Neighbor (ANN) search) to identify candidate pages having similar elements to a selected anchor page. The nearest neighbor search identifies a set of pages that may be suitable for interlinking within a linking module.

In some embodiments, the retrieval module 134 generates (e.g., determines) a relevance score for each page candidate in the candidate page data 126. The relevance score is representative of a relevance of each candidate page with respect to a selected anchor page. For example, the relevance score may be generated based on a distance between the selected anchor page and each corresponding candidate page in the set of similar pages 136 utilizing a distance as determined by a nearest neighbor search. The relevance score may include a value within any suitable threshold, such as, for example, a value between 0 and 1, a value between 0 and 10, a value between 1 and 10, etc.

In some embodiments, the retrieval module 134 applies a threshold to limit or truncate the set of similar pages 136 provided for further processing. For example, the retrieval module 134 may eliminate (e.g., remove from the set of similar pages 136) candidate pages having a relevance score below a predetermined threshold. The predetermined threshold may include a static value or a dynamic value. For example, where a relevance score is represented as a value between 0 and 1, a static threshold value such as 0.5, 0.8, 0.9, etc., may be applied and all candidate pages having a relevance score below the threshold (where a higher relevance score indicates a higher relevance/closer distance) may be removed. As another example, a dynamic threshold may be identified based on relevance scores for the set of eligible candidate pages. A dynamic threshold may include, for example, a mean, a mode, a median, a percentile, etc.

The set of similar pages 136 may include candidate pages having a relevance score above the predetermined threshold. Each page in the set of similar pages 136 may be provided in conjunction with a corresponding page embedding (e.g., a keyword embedding) and a corresponding relevance score. The page data for each included candidate page may be provided in the set of similar pages 136 or may be omitted and only identifiers, embeddings, and relevance scores may be provided. In embodiments without thresholding, the set of similar pages 136 may include each candidate page in the eligible candidate page data 126.

The set of similar pages 136 is provided to a ranking module 140 that ranks each candidate page in the set of similar pages 136 based on the corresponding relevance score and one or more page parameters. The page parameters may include, but are not limited to, seasonal parameters (e.g., seasonal tags, seasonal objects included in the page, etc.), page demand, page quality, search engine optimization potential, etc. The page demand parameter is representative of an interaction rate for a page candidate in response to keyword searches via one or more interface elements, such as a search engine. The page quality parameter is representative of a quality metric for each page candidate, such as a metric quantifying the quality of content, objects, linked elements, or other components of a page candidate. The search engine optimization potential parameter is representative of the impact a page candidate may have on search engine optimization (e.g., automated network traversal) when used for search engine optimization. Although specific embodiments are discussed herein, it will be appreciated that any suitable set of parameters may be used in conjunction with the relevance score to rank page candidates. The ranking module 140 generates a ranked set of candidate pages 142.

In some embodiments, the ranked set of candidate pages 142 is provided to a diversification module 144 that diversifies the set of candidate pages to be linked with respect to a selected anchor page. The diversification module 144 may re-rank the ranked set of candidate pages 142 to de-emphasize candidate pages having a quantity of pre-existing links above a predetermined threshold. For example, the diversification module 144 may generate a diversification score for each candidate page based on a pre-existing quantity of links to the corresponding candidate page in the network environment. In one non-limiting embodiment, the diversification score may include a binary value, such as a value of zero when a page candidate has a quantity of links within the network environment above a predetermined threshold and a value of one when the candidate page has a quantity of links within the network environment below the predetermined threshold. In other embodiments, the diversification score may be determined as a ratio or other value representative of a percentage of links for each candidate page.

The diversification module 144 outputs a set of top-ranked candidate pages 146 from the re-ranked set of candidate pages for inclusion in the corresponding anchor page. The set of top-ranked candidate pages 146 may include the N top-ranked candidate pages, where N is an integer greater than one. In some embodiments, the diversification module 144 applies one or more preselection criteria to select a set of top-ranked candidate pages 146 for one or more page types or purposes. For example, in some embodiments, the diversification module 144 may apply selection criteria based on page type information to select a set of top-ranked candidate pages 146 matching the selection criteria for each page type, such as, for example, a topic page selection criteria set, a browse page selection criteria set, a seasonal page selection criteria set, etc.

In some embodiments, the diversification module 144 substitutes a seasonal anchor page for a corresponding evergreen anchor page. For example, in some embodiments, the diversification module 144 may identify substantially similar seasonal anchor pages and evergreen anchor pages based on a similarity score (e.g., a seasonal page having a similarity above a predetermined threshold may be considered a substitute for an evergreen anchor page). The diversification module 144 may replace a current evergreen anchor page with a seasonal page and generate a set of top-ranked candidate pages 146 for the corresponding seasonal page. Replacement of evergreen pages with seasonal pages may further diversify network interfaces during automated traversal, indexing, searching, or other processes during seasonally appropriate time periods. In some embodiments, the diversification module 144 may flag or otherwise indicate an association between an evergreen anchor page and a seasonal anchor page that allows for substitution of the seasonal anchor page by a serving process when a request for the evergreen anchor page is received. The flag or other indication may be stored in conjunction with the modified anchor page data 150 discussed further below.

The set of top-ranked candidate pages 146 is provided to a page update module 148 that updates the corresponding anchor page to include programmatically generated links (e.g., hyperlinks, embedded links) to the set of top-ranked candidate pages 146. The generated links may be added to any suitable portion of the corresponding anchor page, such as, for example, a link module section of the selected anchor page that is utilized by automated network traversal processes, such as search processes, to identify linkages between pages within a network environment, such as links between webpages. The link module may include a non-rendered (e.g., non-visual) portion of an anchor page that includes links to other, relevant pages that are available to automated traversal or indexing processes. The page update module 148 outputs modified anchor page data 150 for use in interface generation, automated network traversal, and/or any other suitable network or interface task.

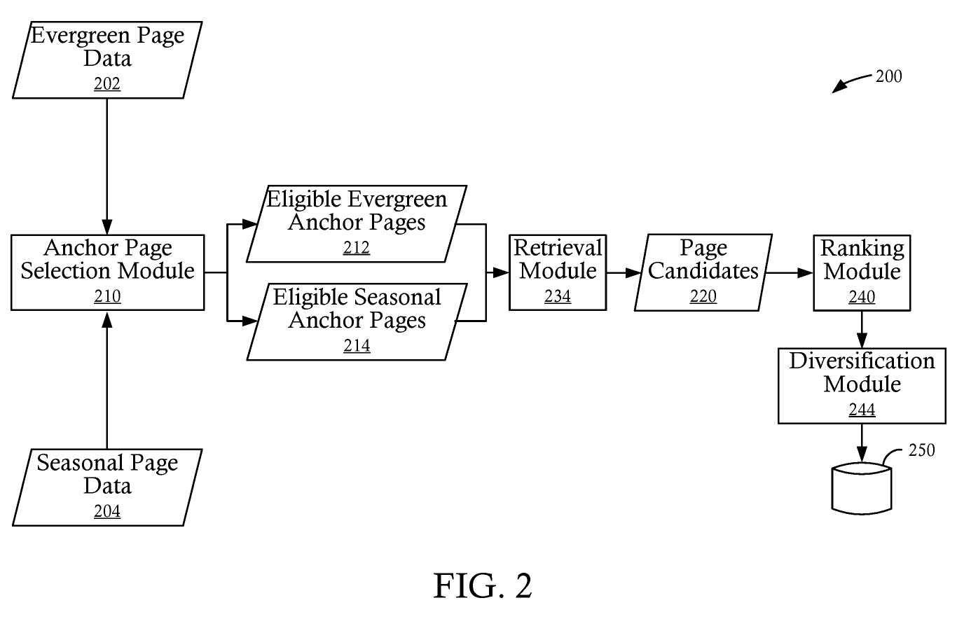

FIG. 2 depicts an example system 200 for generating linked “evergreen” anchor pages and linked “seasonal” anchor pages, in accordance with some embodiments. The system 200 may be implemented in the same and/or a similar computing device as link generation computing device 102. Evergreen pages refer to pages that maintain a consistent theme or style without changing due to discrete events and seasonal anchor pages refer to pages that are generated specifically or updated for one or more discrete events. As one non-limiting example, an evergreen page may include a default browse page for a network environment that may be utilized as an interface page at any point throughout a calendar year. Additional, event-specific browse pages (e.g., seasonal browse pages) may be generated for specific events occurring throughout a calendar year, such as holiday-specific browse pages, month-specific browse pages, and repeating events that lack a set yearly date (e.g., individual birthdays, anniversaries). In some embodiments, evergreen pages and seasonal pages may have link sets generated according to different parameters.

As illustrated in FIG. 2, evergreen page data 202 and seasonal page data 204 may be received by an anchor page selection module 210 implemented by one or more systems, such as a link generation computing device 102. The evergreen page data 202 may include a set of evergreen candidate pages. The evergreen page data 202 may include all evergreen pages available within a network interface or may include a subset of evergreen pages. For example, a subset of evergreen pages may be selected based on one or more selection criteria such as network interface topic identifications (e.g., identification of topics that are associated with pages within the network interface), one or more browse identifications (e.g., identifications of browse groupings or pages that are associated within the network interface), item identifications (e.g., a selection of a subset of items that are associated with a network interface, such as through a network catalog), and/or any other suitable selection criteria. Similarly, seasonal page data 204 may include all seasonal pages available within a network interface or may include a subset of the seasonal pages. For example, a subset of seasonal pages may be selected based on one or more selection criteria such as seasonal metadata, seasonal page lists, identified seasonal anchor pages, or seasonal keyword lists.

In some embodiments, the evergreen page data 202 and/or the seasonal page data 204 may include page data associated with each page included in the dataset. For example, the evergreen page data 202 may include topic data, browse data, and/or item data (e.g., item identifiers) for elements included in, or associated with, each evergreen page in the evergreen page data 202. Similarly, the seasonal page data 204 may include topic data, browse data, category data, seasonal grouping data, and/or item data for elements included in or associated with each seasonal page in the seasonal page data 204.

In some embodiments, an anchor page selection module 210 selects a set of eligible evergreen anchor pages 212 and a set of eligible seasonal anchor pages 214. The anchor page selection module 210 may select corresponding anchor pages using any suitable selection criteria. For example, in some embodiments, a set of seasonal anchor pages are dynamically identified using one or more of a season name, a seasonal browse or category list, one or more related keywords, etc. As another example, in some embodiments, anchor pages in the evergreen page data 202 and/or the seasonal page data 204 may be labeled with a tag (e.g., a metadata tag) indicating that the page is within a universe of anchor pages.

In some embodiments, anchor pages identified within the set of eligible evergreen anchor pages 212 and the set of eligible seasonal anchor pages 214 are divided into multiple categories. For example, anchor pages may be divided into item pages, browse pages, category pages, topic pages, and/or any other suitable category of pages within a network environment. The category of an anchor page may be determined based on data associated with an anchor page (e.g., metadata, tags), based on layout or templates used in the page, interface elements within the page, and/or any other suitable determination. In some embodiments, the evergreen page data 202 is divided into anchor pages (e.g., the set of eligible evergreen anchor pages 212) and non-anchor pages (e.g., other pages in the evergreen page data 202) and the seasonal page data 204 is divided into anchor pages (e.g., the set of eligible seasonal anchor pages 214) and non-anchor pages (e.g., other pages in the seasonal page data 204).

The evergreen page data 202, the seasonal page data 204, the set of eligible evergreen anchor pages 212, and the set of eligible seasonal anchor pages 214 are provided to a retrieval module 234. The retrieval module 234 may be similar in many respects to the retrieval module 134 discussed above with respect to FIG. 1, and a similar description is not repeated herein. The retrieval module 234 may implement one or more of an embedding generation process (e.g., a BERT-based embedding process), a nearest neighbor search (e.g., an ANN search), and/or a threshold filtering process to generate a set of page candidates 220 for each anchor page in the set of eligible evergreen anchor pages 212 or the set of eligible seasonal anchor pages 214.

In some embodiments, a first set of parameters or processes is applied by the retrieval module 234 for the set of eligible evergreen anchor pages 212 and a second set of parameters or processes is applied for the set of eligible seasonal anchor pages 214. For example, the retrieval module 234 may implement a first threshold filtering process based on a first set of parameters for the set of evergreen anchor pages that limits each set of page candidates for each evergreen anchor page based on a category of the corresponding anchor page, such as limiting a set of page candidates for item anchor pages to N corresponding topic page candidates and M corresponding browse page candidates (where N and M are integers greater than zero), limiting a set of page candidates for browse anchor pages to N topic page candidates, limiting a set of page candidates for category anchor pages to N corresponding browse page candidates and N corresponding topic page candidates, limiting a set of page candidates for topic anchor pages to N item page candidates, M topic page candidates, and O browse page candidates (where O is similarly an integer greater than zero), etc. Similarly, the retrieval module 234 may implement a second threshold filtering process based on a second set of parameters for the set of seasonal anchor pages that limits each set of page candidates for each seasonal anchor page based on a category of the corresponding anchor page, such as limiting a set of page candidates for seasonal item anchor pages to N other seasonal pages, limiting a set of page candidates for seasonal browse anchor pages to N other seasonal pages, limiting a set of page candidates for seasonal category pages to N other seasonal pages, etc. Although specific embodiments are discussed herein, it will be appreciated that any suitable parameters, such as any suitable thresholding parameters, may be applied based on a type of anchor page (e.g., evergreen vs. seasonal), a sub-type of an anchor page (e.g., item, browse, category, topic), or any combination thereof.

The set of page candidates 220 and one or more corresponding anchor pages, (e.g., one or more evergreen anchor pages selected from the set of eligible evergreen anchor pages 212 or one or more seasonal anchor pages selected from the set of eligible seasonal anchor pages 214), are provided to a ranking module 240 to implement a reranking process for the set of page candidates 220. The ranking module 240 may be similar in many respects to the ranking module 140 discussed above with respect to FIG. 1, and similar description is not repeated herein. In some embodiments, the ranking module 240 applies a ranking model or process that applies specific ranking (e.g., weighting) criteria based on a page type or sub-type of a corresponding anchor page. For example, the ranking module 240 may apply a first set of ranking criteria for a set of ranking parameters for ranking of page candidates for an item anchor page and a second set of ranking criteria for the set of ranking parameters for ranking of page candidates for a topic anchor page. In some embodiments, different sets of parameters may be used for ranking sets of page candidates for different types or sub-types of anchor pages.

The ranking module 240 may provide a ranked page set, such as a ranked set of candidate pages 142 discussed above with respect to FIG. 1, to a diversification module 244. The diversification module 244 may be similar to the diversification module 144 discussed above with respect to FIG. 1, and similar description is not repeated herein. The diversification module 244 may output data for updating a corresponding anchor page to include links to a selected set of page candidates to be linked on the corresponding anchor page. The updated anchor page may be provided to one or more page stores, such as page store 250. The page store 250 may include one or more containers or storage mechanisms and may store each type or sub-type of anchor page in a corresponding container. The page store 250 may be used to serve page data to a network interface, such as providing the updated anchor page data when an automated traversal process requests a corresponding anchor page from the network interface.

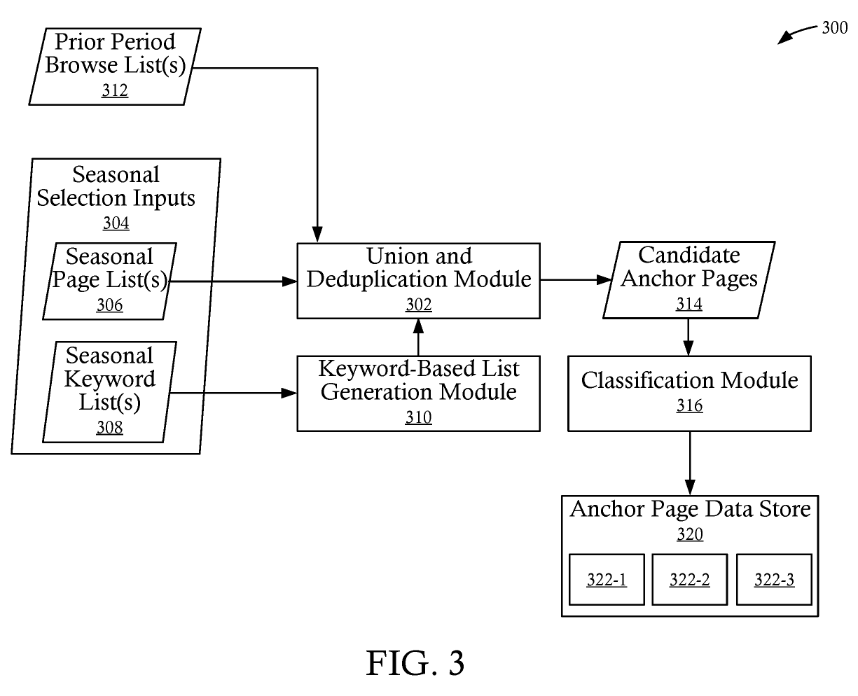

FIG. 3 depicts an example system 300 for selecting a set of candidate anchor pages 314 for link generation, in accordance with some embodiments. The system 300 may be implemented in the same and/or a similar computing device as link generation computing device 102. A union and deduplication module 302 receives a set of seasonal selection inputs 304 (e.g., seasonal anchor page selection inputs) that includes a set of seasonal pages to be filtered to identify seasonal anchor page candidates for link generation. The set of seasonal selection inputs 304 may include a set of seasonal page lists 306 (e.g., one or more page lists identifying seasonal anchor browse and/or category pages or elements), a seasonal keyword list 308, or other suitable parameters. In some embodiments, prior to being provided to the generation and deduplication module 302, the seasonal keyword list 308 is provided to a keyword-based list generation module 310 that generates one or more additional lists of seasonal anchor page candidates based on text matching between the seasonal keyword list 308 and sets of seasonal pages. The keyword matching may include a direct keyword matching, a semantic matching, or any other suitable keyword matching process. The union and deduplication module 302 may receive additional lists or sets of candidate anchor pages, such as a browse list 312 of pages from a prior calendar period corresponding to the same seasonal period as seasonal pages in the set of seasonal page lists 306.

The union and deduplication module 302 combines the received lists of anchor page candidates (e.g., the set of seasonal page lists 306), a set of keyword-generated anchor page lists, the set of browse lists 312, or any other set or lists of candidate anchor pages, and outputs a final set of candidate anchor pages 314. The final set of candidate anchor pages 314 is provided to a classification module 316, which classifies each candidate anchor page in the final set of candidate anchor pages 314 into one or more types or sub-types, such as classifying each candidate anchor page as one of an item page, a browse page, or a category page. Each classified candidate anchor page is stored in an anchor page data store 320. The anchor page data store 320 may include one or more containers that each store a sub-type of candidate anchor pages, such as a first container 322-1 to store item candidate anchor pages, a second container 322-2 to store browse candidate anchor pages, and a third container 322-3 to store category page candidate anchor pages. In some embodiments, the union and deduplication module 302 prioritizes a type of anchor page, for example, retaining seasonal anchor pages that are substantially duplicates of evergreen anchor pages while removing the corresponding evergreen anchor pages.

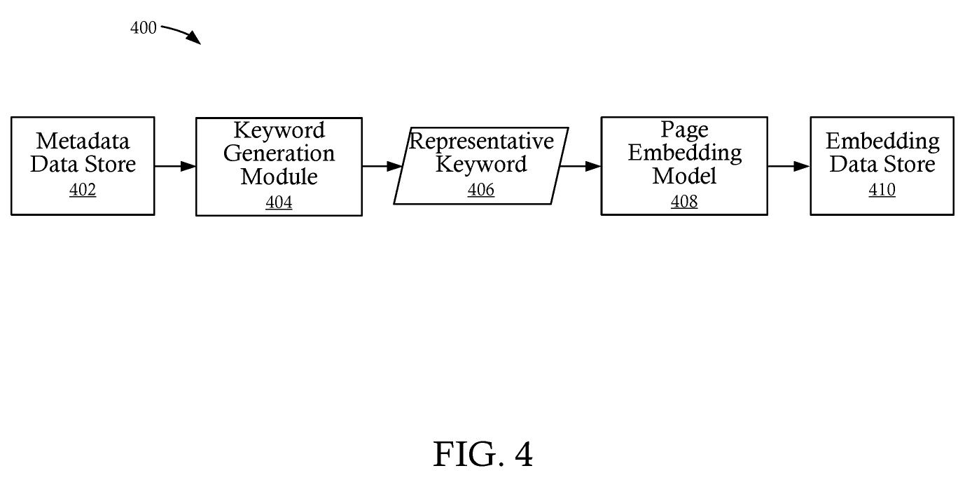

FIG. 4 depicts an example system 400 for page embedding generation, in accordance with some embodiments. The system 400 may be implemented in the same and/or a similar computing device as link generation computing device 102. A metadata data store 402 stores metadata for each page or a subset of pages in a network environment. Page metadata stored in the metadata data store 402 may be used to classify each page into a page sub-type, such as a topic page, a browse page, an item page, a category page, or any other page sub-type classification. A keyword generation module 404 generates at least one representative keyword 406 for each page in a set of pages represented in the metadata data store 402. The keyword generation module 404 may apply a sub-type based keyword generation process for each received page. For example, in some embodiments, a representative keyword 406 may be generated for a topic page based on a first keyword generation process that utilizes a page identification, a topic category name, and one or more related item identifiers, a representative keyword 406 may be generated for a browse page based on a category path (such as a reversed primary category path), a representative keyword 406 may be generated for an item page based on an item name and a category path, a representative keyword 406 may be generated for a category page based on one or more related browse page embedding keywords and one or more items related to the category page, etc.

The generated representative keyword 406 for each page is provided to a page embedding model 408. The page embedding model 408 may include a two tower BERT embedding model. The page embedding model 408 generates an embedding for each received representative keyword 406. Generated embeddings may be stored in a data store, such as embedding data store 410. The embedding data store 410 may include one or more containers that each store embeddings associated with a page type.

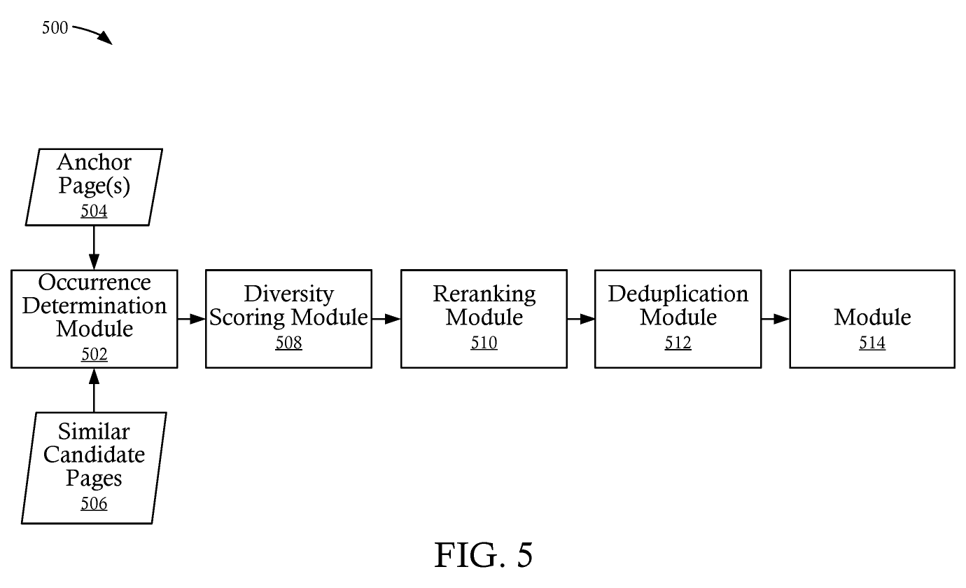

FIG. 5 depicts an example system 500 for page diversification, in accordance with some embodiments. The system 500 may be implemented in the same and/or a similar computing device as link generation computing device 102. The system 500 includes an occurrence determination module 502 that receives one or more anchor pages 504 and a set of similar candidate pages 506, which may be selected according to one or more processes or methods disclosed herein. The set of similar candidate pages 506 includes a plurality of page candidates for linkage with respect to one of the corresponding anchor pages 504. Each of the similar candidate pages includes a generated ranking score based on a similarity between the page candidate and one of the one or more corresponding anchor pages 504. For example, the set of similar candidate pages 506 may include a ranked page set generated by ranking module, such as a ranked set of candidate pages 142 generated by ranking module 140 discussed above with respect to FIG. 1. In some embodiments, each page candidate in the set of similar candidate pages 506 has a similarity score (e.g., a similarity score generated by a retrieval module 134) and/or a rank (e.g., a rank position obtained from a ranked set of candidate pages 142).

The occurrence determination module 502 determines (e.g., calculates, counts, estimates) an occurrence rate for each page candidate representative of the quantity of links to the corresponding page candidate that exist in the network environment. For example, where a page candidate is linked by X quantity of other pages, the occurrence rate for the page candidate may be X or it may be X divided by some scaling factor. In some embodiments, the occurrence rate is based on a snapshot of the network environment (e.g., a count of links) obtained at a predetermined time period, such as the prior time period. In such embodiments, the occurrence rate represents a historical occurrence rate for the predetermined time period.

The occurrence rate is provided to a diversification scoring module 508 that generates a diversification score for each page candidate in the set of similar candidate pages 506. The diversification score may be generated based on the occurrence rate for linkages for a respective page candidate. For example, in some embodiments, a threshold occurrence rate is used to set a binary value for the diversification score such that an occurrence rate greater than a threshold results in a diversification score of zero and an occurrence rate less than or equal to the threshold results in a diversification score of one. In some embodiments, the diversification score may be determined based on an overall quantity of occurrences and a quantity of occurrences for a specific page candidate, for example, based on a percentage of the overall occurrences assignable to a page candidate.

The set of similar candidate pages 506, a corresponding similarity score or similarity ranking, and a corresponding diversity score is provided to a re-ranking module 510 that re-ranks each of the page candidates for an anchor page based on the corresponding diversity scores and the corresponding similarity scores. For example, in some embodiments, the set of similar candidate pages 506 are first ranked by diversity score and secondarily ranked by similarity score. Continuing the example from above, where the diversity score is zero when an occurrence rate is greater than a threshold and is one where the occurrence rate is less than or equal to the threshold, page candidates having diversity scores of one (e.g., having an occurrence rate equal to or less than the threshold) are all ranked above page candidates having a diversity score of zero. Subsequently, the page candidates having a diversity score of one are ranked according to similarity score and the page candidates having a diversity score of zero are separately ranked according to similarity score, resulting in a final ranking that prioritizes diversity score.

In some embodiments, a deduplication module 512 receives the reranked set of similar candidate pages 506 and removes duplicated pages within page sets and between page sets (e.g., keeping only one instance of an anchor page responsive to the anchor page being included in both a set of seasonal anchor pages and a set of evergreen anchor pages). The one or more anchor pages and corresponding reranked set of similar candidate pages 506 are sorted by type or sub-type and a page update module 514 selects a set of N top ranked page candidates from the reranked, diversified set of similar candidate pages 506 for each anchor page in the one or more anchor pages 504.

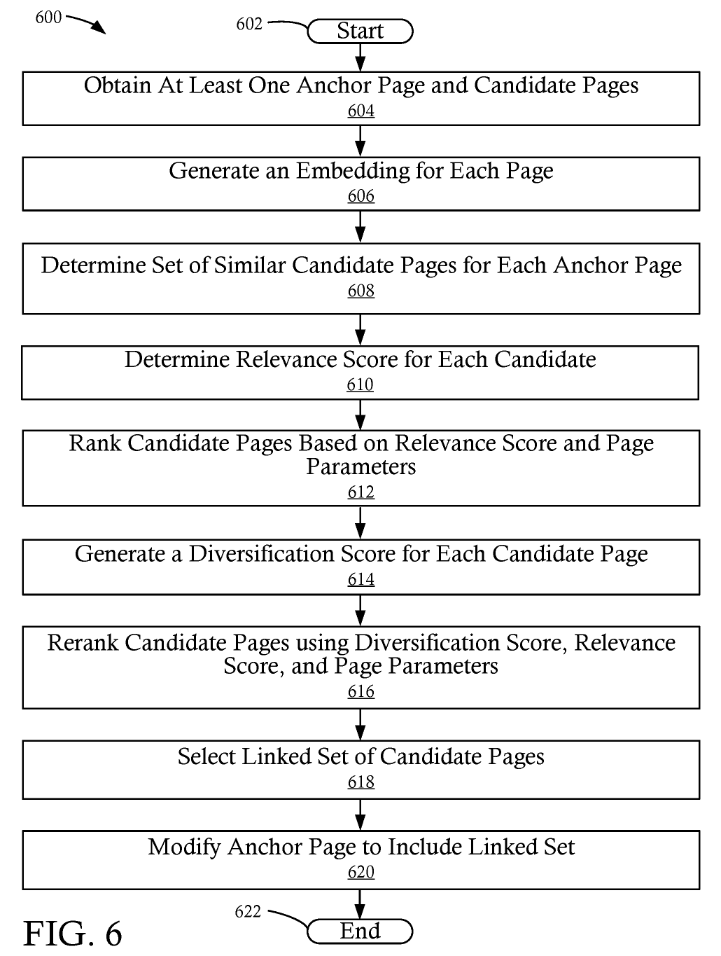

FIG. 6 is a flow diagram depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The method shown in FIG. 6 may be implemented in the form of executable instructions stored on machine-readable media and executed by a processing resource and/or in the form of electronic circuitry. For example, aspects of the methods may be described below as being performed by a link generation system, an example of which may be the link generation process 128 running on a hardware processing resource 104 of the link generation computing device 102 described above. Additionally, other aspects of the methods described below may be described with reference to other elements shown in FIG. 1 for non-limiting illustration purposes.

FIG. 6 is a flowchart depicting an example method 600 for automatically generating linked anchor pages, in accordance with some embodiments. Method 600 starts at block 602 and continues to block 604, where at least one anchor page and a set of eligible page candidates are received. The one or more anchor pages may be received as page data, such as anchor page data 124 illustrated in FIG. 1. Similarly, the set of eligible page candidates may be received as page data such as the candidate page data 126 illustrated in FIG. 1.

At block 606, an embedding is generated for each of the at least one anchor page and each of the page candidates in the set of eligible page candidates. The embedding may be generated by any suitable embedding model, such as a two tower BERT-based embedding model. The embeddings may be based on representative keywords generated for each page. The representative keywords may be generated in a similar manner for each of the at least one anchor page and each of the page candidates or may be generated according to a specific generation process for a corresponding type or sub-type of each of the at least one anchor page and each of the page candidates.

At block 608, a set of similar candidate pages is determined for each anchor page. The set of similar candidate pages may include, but is not limited to, pages having similar types, sub-types, interface elements, items, campaigns, etc. The set of similar candidate pages may be determined by comparing previously generated embeddings, for example, based on a distance, similarity, or other comparison of previously generated representative keyword embeddings.

At block 610, a relevance score for each page candidate with respect to the at least one anchor page is generated. The relevance score is representative of the relevance, or relatedness, between each page candidate and each of the at least one anchor page. The relevance score may be generated by a scoring module based on the set of similar attributes, the embedding generated for each corresponding page, or both.

At block 612, each of the candidate pages in the set of eligible candidate pages is ranked based on the determined relevance score and one or more page parameters for each of the candidate pages. The page parameters may include, but are not limited to, seasonal parameters (e.g., seasonal tags, seasonal objects included in the page), page demand, page quality, search engine optimization potential, etc.

At block 614, a diversification score is generated for each candidate page in the set of eligible candidate pages. The diversification score may be based on an occurrence of the candidate page (e.g., an occurrence of linkages to the candidate page) in existing network interface pages. In some embodiments, the diversification score is a binary score representative of whether the corresponding candidate page has been linked more than a threshold quantity of times or less than a threshold quantity of times.

At block 616, the candidate pages in the set of eligible candidate pages are reranked based on the diversity score, the relevance score, and, optionally, the page parameters. In some embodiments, the reranking may prioritize one or more scores or parameters, such as performing an initial ranking based on the diversity score for each candidate page and subsequently performing a secondary ranking (e.g., ranking within each strata of diversity score) based on the relevance score and page parameters. As another example, in some embodiments, the reranking may utilize a weighted ranking that prioritizes one or more scores or parameters, such as a diversity score, by providing a higher weighting to the corresponding parameter.

At block 618, a linked set of candidate pages is selected from the reranked set of candidate pages based on the reranking. For example, in some embodiments, a set of top N ranked candidate pages is selected from the set of candidate pages to be included in the linked set of candidate pages, where N is an integer greater than one. The selected linked set is representative of a diverse set of candidate pages that have a high relevance to the anchor page to be updated. Inclusion of the diverse, highly relevant candidate pages increases the value of the corresponding anchor page information for automated traversal, indexing, or other uses of the anchor page.

At block 620, the page data for the corresponding anchor page is modified to include the linked set of candidate pages. The linked set of candidate pages may be added to any suitable portion of the anchor page. For example, in some embodiments, a link to each of the linked set of candidate pages is added to a link module of the anchor page. The link module may include a non-rendered (e.g., non-visual) portion of an anchor page that includes links to other, relevant pages that are available to automated traversal or indexing processes. The modified anchor page may be provided to a data store for use in one or more additional processes, such as an automated network traversal process, an automated indexing process, an automated page serving process, an automated search process, and/or any other suitable automated process. At block 622, the method 600 ends.

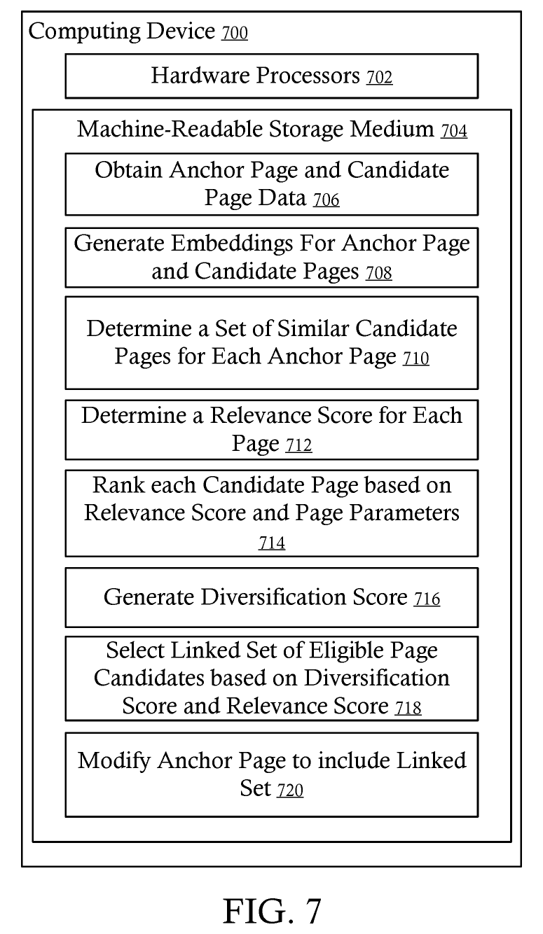

FIG. 7 depicts an example system 700 that includes non-transitory, machine-readable media 704 encoded with example instructions executable by processing resource 702. In some implementations, the system 700 may be useful for implementing aspects of the link generation process 128 of FIG. 1. For example, the instructions encoded on machine-readable media 704 may be included in instructions 108 of FIG. 1. In some implementations, functionality described with respect to FIG. 1 may be included in the instructions encoded on machine-readable media 704.

The processing resource 702 may include a microcontroller, a microprocessor, central processing unit core(s), an ASIC, an FPGA, and/or other hardware device suitable for retrieval and/or execution of instructions from the machine-readable media 704 to perform functions related to various examples. Additionally or alternatively, the processing resource 702 may include or be coupled to electronic circuitry or dedicated logic for performing some or all of the functionality of the instructions described herein.

The machine-readable media 704 may be any medium suitable for storing executable instructions, such as RAM, ROM, EEPROM, flash memory, a hard disk drive, an optical disc, or the like. In some example implementations, the machine-readable media 704 may be a tangible, non-transitory medium. The machine-readable media 704 may be disposed within the system 700 respectively, in which case the executable instructions may be deemed installed or embedded on the system. Alternatively, the machine-readable media 704 may be a portable (e.g., external) storage medium, and may be part of an installation package.

As described further herein below, the machine-readable media 704 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 7.

With reference to FIG. 7, the machine-readable media 704 includes instructions 706-720. Instructions 706, when executed, cause the processing resource 702 to obtain at least one anchor page and a set of eligible candidate pages. The one or more anchor pages may be received as page data, such as anchor page data 124 illustrated in FIG. 1. Similarly, the set of eligible page candidates may be received as page data such as the candidate page data 126 illustrated in FIG. 1.

Instructions 708, when executed, cause the processing resource 702 to generate embeddings for the at least one anchor page and each of the candidate pages in the set of eligible candidate pages. The embedding may be generated by any suitable embedding model, such as a two tower BERT-based embedding model. The embeddings may be based on representative keywords generated for each page. The representative keywords may be generated in a similar manner for each of the at least one anchor page and each of the page candidates or may be generated according to a specific generation process for a corresponding type or sub-type of each of the at least one anchor page and each of the page candidates.

Instructions 710, when executed, cause the processing resource 702 to determine a set of similar candidate pages for each anchor page. The set of similar candidate pages may include, but is not limited to, pages having similar types, sub-types, interface elements, items, campaigns, etc. The set of similar candidate pages may be determined by comparing previously generated embeddings, for example, based on a distance, similarity, or other comparison of previously generated representative keyword embeddings.

Instructions 712, when executed, cause the processing resource 702 to generate a relevance score for each page candidate with respect to the at least one anchor page. The relevance score is representative of the relevance, or relatedness, between each page candidate and each of the at least one anchor page. The relevance score may be generated by a scoring module based on the set of similar attributes, the embedding generated for each corresponding page, or both.

Instructions 714, when executed, cause the processing resource 702 to rank each of the candidate pages in the set of eligible candidate pages based on the determined relevance score and one or more page parameters for each of the candidate pages. The page parameters may include, but are not limited to, seasonal parameters (e.g., seasonal tags, seasonal objects included in the page), page demand, page quality, search engine optimization potential, etc.

Instructions 716, when executed, cause the processing resource 702 to generate a diversification score for each candidate page in the set of eligible candidate pages. The diversification score may be based on an occurrence of the candidate page (e.g., an occurrence of linkages to the candidate page) in existing network interface pages. In some embodiments, the diversification score is a binary score representative of whether the corresponding candidate page has been linked more than a threshold quantity of times or less than a threshold quantity of times.

Instructions 718, when executed, cause the processing resource 702 to select a linked set of candidate pages based on the diversification score and the relevance score. For example, the candidate pages may be reranked based on the diversity score, the relevance score, and, optionally, the page parameters. The reranking may prioritize one or more scores or parameters, such as performing an initial ranking based on the diversity score for each candidate page and subsequently performing a secondary ranking (e.g., ranking within each strata of diversity score) based on the relevance score and page parameters. A set of top N ranked candidate pages is selected from the set of candidate pages to be included in the linked set of candidate pages, where N is an integer greater than one. The selected linked set is representative of a diverse set of candidate pages that have a high relevance to the anchor page to be updated. Inclusion of the diverse, highly relevant candidate pages increases the value of the corresponding anchor page information for automated traversal, indexing, or other uses of the anchor page.

Instructions 720, when executed, cause the processing resource 702 to modify the page data for the corresponding anchor page to include the linked set of candidate pages. The linked set of candidate pages may be added to any suitable portion of the anchor page. For example, in some embodiments, a link to each of the linked set of candidate pages is added to a link module of the anchor page. The link module may include a non-rendered (e.g., non-visual) portion of an anchor page that includes links to other, relevant pages that are available to automated traversal or indexing processes. The modified anchor page may be provided to a data store for use in one or more additional processes, such as an automated network traversal process, an automated indexing process, an automated page serving process, an automated search process, and/or any other suitable automated process.

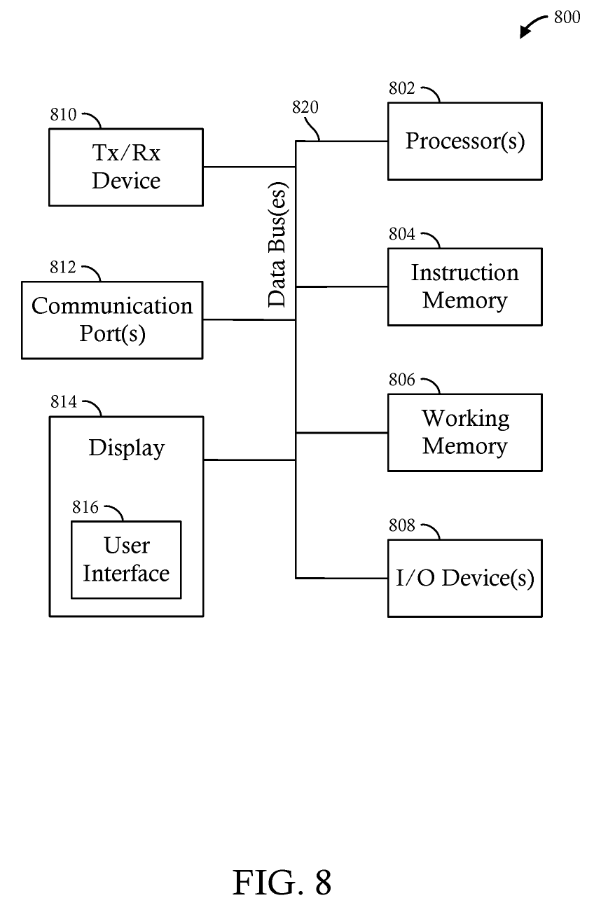

FIG. 8 depicts an example computer system that implements one or more of the disclosed processes, in accordance with some embodiments. Although FIG. 8 is described with respect to certain components shown therein, it will be appreciated that the elements of the computing device 800 may be combined, omitted, and/or replicated. In addition, it will be appreciated that additional elements other than those illustrated in FIG. 8 may be added to the computing device. The computing device 800 may be useful for implementing one or more systems disclosed herein, such as systems 100, 200, 300, 400, or 500 discussed above.

As shown in FIG. 8 the computing device 800 may include one or more processing resources 802, instruction memory 804, working memory 806, input/output devices 808, transceiver 810, communication port(s) 812, display 814, and/or any other suitable elements each operatively coupled to one or more data buses 820. The data buses 820 allow for communication among the various components. The data buses 820 may include wired, or wireless communication channels.

The one or more processing resources 802 may include any processing circuitry operable to control operations of the computing device 800. In some embodiments, the one or more processing resources 802 include one or more distinct processors, each having one or more cores (e.g., processing circuits). Each of the distinct processors may have the same or different structure. The one or more processing resources 802 may include one or more central processing units (CPUs), one or more graphics processing units (GPUs), ASICs, digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 802 may also be implemented by a controller, a microcontroller, an ASIC, an FPGA, or a programmable logic device (PLD), etc.

In some embodiments, the one or more processing resources 802 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include network applications, local applications, data I/O applications, user interaction applications, etc.

The instruction memory 804 may store instructions that are accessed (e.g., read) and executed by at least one of the one or more processing resources 802. For example, the instruction memory 804 may be a non-transitory, computer-readable storage medium such as a ROM, an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 802 may perform a certain function or operation by executing code stored on the instruction memory 804, embodying the function or operation. For example, the one or more processing resources 802 may execute code stored in the instruction memory 804 to perform one or more of any function, method, or operation disclosed herein.

Additionally, the one or more processing resources 802 may store data to, and read data from, the working memory 806. For example, the one or more processing resources 802 may store a working set of instructions to the working memory 806, such as instructions loaded from the instruction memory 804. The one or more processing resources 802 may also use the working memory 806 to store dynamic data created during one or more operations. The working memory 806 may include, for example, RAM such as a static random access memory (SRAM) or dynamic random access memory (DRAM), Double-Data-Rate DRAM (DDR-RAM), synchronous DRAM (SDRAM), an EEPROM, flash memory (e.g., NOR and/or NAND flash memory), CAM, polymer memory (e.g., ferroelectric polymer memory), phase-change memory (e.g., ovonic memory), ferroelectric memory, SONOS memory, a removable disk, CD-ROM, any non-volatile memory, or any other suitable memory. Although embodiments are illustrated herein including separate instruction memory 804 and working memory 806, it will be appreciated that the computing device 800 may include a single memory unit that operates as both instruction memory and working memory. Further, although embodiments are discussed herein including non-volatile memory, it will be appreciated that computing device 800 may include volatile memory components in addition to at least one non-volatile memory component.

In some embodiments, the instruction memory 804 and/or the working memory 806 includes an instruction set, in the form of a file for executing various methods, such as methods for automatically generating linkage information and updating anchor pages to include identified links, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments, a compiler or interpreter converts the instruction set into machine-executable code for execution by the one or more processing resources 802.

The input/output devices 808 may include any suitable device that allows for data input or output. For example, the input/output devices 808 may include one or more of a keyboard, touchpad, mouse, stylus, touchscreen, physical button, speaker, microphone, keypad, click wheel, motion sensor, camera, and/or any other suitable input or output device.

The transceiver 810 and/or the communication port(s) 812 allow for communication with a network. For example, where the communication network is a cellular network, the transceiver 810 allows communications with the cellular network. In some embodiments, the transceiver 810 is selected based on the type of the communication network the computing device 800 will be operating in. The one or more processing resources 802 are operable to receive data from, or send data to, a network, via the transceiver 810.

The communication port(s) 812 may include any suitable hardware, software, and/or combination of hardware and software that is capable of coupling the computing device 800 to one or more networks and/or additional devices. The communication port(s) 812 may be arranged to operate with any suitable technique for controlling information signals using a desired set of communications protocols, services, or operating procedures. The communication port(s) 812 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 812 allows for the programming of executable instructions in the instruction memory 804. In some embodiments, the communication port(s) 812 allow for the transfer (e.g., uploading or downloading) of data, such as machine learning model training data.

In some embodiments, the communication port(s) 812 couples the computing device 800 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 810 and/or the communication port(s) 812 utilize one or more communication protocols. Examples of wired protocols may include, but are not limited to, USB communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 814 may be any suitable display, and may display the user interface 816. The user interfaces 816 may enable user interaction with interface pages including programmatically generated linkage information. For example, the user interface 816 may be a user interface for an application of a network environment operator that allows a user to view and interact with the operator’s website. In some embodiments, a user may interact with the user interface 816 by engaging the input/output devices 808. In some embodiments, the display 814 may be a touchscreen, where the user interface 816 is displayed on the touchscreen.

The display 814 may include a screen such as a Liquid Crystal Display (LCD) screen, a light-emitting diode (LED) screen, an organic LED (OLED) screen, a movable display, a projection, etc. In some embodiments, the display 814 may include a coder/decoder, also known as Codecs, to convert digital media data into analog signals. For example, the visual peripheral output device may include video Codecs, audio Codecs, or any other suitable type of Codec.

In some embodiments, the computing device 800 may be a computer, workstation, laptop, server such as a cloud-based server, or any other suitable device. In some embodiments, the computing device 800 is a server that includes one or more processing units, such as one or more GPUs, one or more CPUs, and/or one or more processing cores. The computing device 800 may, in some embodiments, execute one or more virtual machines. In some embodiments, processing resources (e.g., capabilities) of the computing device 800 are offered as a cloud-based service (e.g., cloud computing).

In some embodiments, a computing device implements one or more modules or engines, each of which is constructed, programmed, configured, or otherwise adapted, to autonomously carry out a function or set of functions. A module/engine may include a component or arrangement of components implemented using hardware, such as by an ASIC or FPGA, for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices) that execute an operating system, system programs, and application programs, while also implementing the engine using multitasking, multithreading, distributed (e.g., cluster, peer-peer, cloud) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

Although embodiments are illustrated herein including certain systems and/or devices, it will be appreciated that additional systems, servers, storage mechanisms, etc. may be included. In addition, although embodiments are illustrated herein as having individual, discrete systems, it will be appreciated that, in some embodiments, one or more systems may be combined into a single logical and/or physical system. Similarly, although embodiments are illustrated as having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

It will be appreciated that automated interface linkage generation and updating as disclosed herein, particularly on large network environments such as e-commerce environments, is only possible with the aid of computer-assisted machine-learning algorithms and techniques, such as the disclosed systems and methods. In some embodiments, machine learning processes including BERT embedding generation models and ranking models are used to perform operations that cannot practically be performed by a human, either mentally or with assistance, such as generating computer-interpretable representations of representative keywords or ranking large quantities of interface pages included in a network environment.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions that, when executed, cause the processor to:
obtain at least one anchor page and a plurality of candidate pages;
generate an embedding for the at least one anchor page and each of the plurality of candidate pages by applying a page embedding model to a representative keyword construction extracted from the at least one anchor page or a candidate page of the plurality of candidate pages;
select a set of similar candidate pages from the plurality of candidate pages using a comparison of the embedding for the at least one anchor page and the embedding for each candidate page in the plurality of candidate pages;
determine a relevance score for each candidate page in the set of similar candidate pages, wherein the relevance score is representative of a relevance of a corresponding candidate page to the at least one anchor page;
generate a diversification score for each candidate page in the set of similar candidate pages;
select a linked set of candidate pages based on the relevance score and diversification score for each candidate page in the set of similar candidate pages; and
modify the at least one anchor page to include a link to each page in the linked set of candidate pages.

2. The system of claim 1, wherein responsive to receiving a request for the at least one anchor page, the processor executes the instructions to display a seasonal anchor page associated with the at least one anchor page.

3. The system of claim 1, wherein the page embedding model comprises a two tower Bidirectional Encoder Representations from Transformers (BERT) model.

4. The system of claim 1, wherein the relevance score is generated by an Approximate Nearest Neighbor (ANN) search.

5. The system of claim 1, wherein the linked set of candidate pages is selected by ranking each candidate page in the set of similar candidate pages based on the relevance score, the diversification score, and a page type.

6. The system of claim 1, wherein the representative keyword construction includes text data extracted from the at least one anchor page or a candidate page of the plurality of candidate pages and an item identifier.

7. The system of claim 1, wherein the at least one anchor page comprises a seasonal anchor page.

8. A computer-implemented method, comprising
obtaining at least one anchor page and a plurality of candidate pages;
generating an embedding for the at least one anchor page and each of the plurality of candidate pages by applying a page embedding model to a representative keyword construction extracted from each of the at least one anchor page or a candidate page of the plurality of candidate pages;
selecting a set of similar candidate pages from the plurality of candidate pages using a comparison of the embedding for the at least one anchor page and the embedding for each candidate page in the plurality of candidate pages;
determining a relevance score for each candidate page in the set of similar candidate pages, wherein the relevance score is representative of a relevance of a corresponding candidate page to the at least one anchor page;
generating a diversification score for each candidate page in the set of similar candidate pages;
selecting a linked set of candidate pages based on the relevance score and diversification score for each candidate page in the set of similar candidate pages; and
modifying the at least one anchor page to include a link to each page in the linked set of candidate pages.

9. The computer-implemented method of claim 8, comprising displaying a seasonal anchor page associated with the at least one anchor page responsive to receiving a request for the at least one anchor page.

10. The computer-implemented method of claim 8, wherein the page embedding model comprises a two tower Bidirectional Encoder Representations from Transformers (BERT) model.

11. The computer-implemented method of claim 8, wherein the relevance score is generated by an Approximate Nearest Neighbor (ANN) search.

12. The computer-implemented method of claim 8, wherein the linked set of candidate pages is selected by ranking each candidate page in the set of similar candidate pages based on the relevance score, the diversification score, and a page type.

13. The computer-implemented method of claim 8, wherein the representative keyword construction includes text data extracted from the at least one anchor page or a candidate page of the plurality of candidate pages and an item identifier.

14. The computer-implemented method of claim 8, wherein the at least one anchor page comprises a seasonal anchor page.

15. A non-transitory computer-readable medium having instructions stored thereon, wherein the instructions, when executed by at least one processor, cause at least one device to perform operations comprising:
obtaining at least one anchor page and a plurality of candidate pages;
generating an embedding for the at least one anchor page and each of the plurality of candidate pages by applying a page embedding model to a representative keyword construction extracted from each of the at least one anchor page or a candidate page of the plurality of candidate pages;
selecting a set of similar candidate pages from the plurality of candidate pages using a comparison of the embedding for the at least one anchor page and the embedding for each candidate page in the plurality of candidate pages;
determining a relevance score for each candidate page in the set of similar candidate pages, wherein the relevance score is representative of a relevance of a corresponding candidate page to the at least one anchor page;
generating a diversification score for each candidate page in the set of similar candidate pages;
selecting a linked set of candidate pages based on the relevance score and diversification score for each candidate page in the set of similar candidate pages; and
modifying the at least one anchor page to include a link to each page in the linked set of candidate pages.

16. The non-transitory computer-readable medium of claim 15, wherein the instructions cause the device to perform operations comprising displaying a seasonal anchor page associated with the at least one anchor page responsive to receiving a request for the at least one anchor page.

17. The non-transitory computer-readable medium of claim 15, wherein the page embedding model comprises a two tower Bidirectional Encoder Representations from Transformers (BERT) model.

18. The non-transitory computer-readable medium of claim 15, wherein the relevance score is generated by an Approximate Nearest Neighbor (ANN) search.

19. The non-transitory computer-readable medium of claim 15, wherein the linked set of candidate pages is selected by ranking each candidate page in the set of similar candidate pages based on the relevance score, the diversification score, and a page type.

20. The non-transitory computer-readable medium of claim 15, wherein the representative keyword construction includes text data extracted from the at least one anchor page or a candidate page of the plurality of candidate pages and an item identifier.
